(19) United States
(12) Patent Application Publication
(10) Pub. No.: US 2018/0088723 A1
(43) Pub. Date: Mar. 29, 2018

(54) ELECTRONIC DEVICE AND METHOD FOR CONTROLLING THE SAME

(71) Applicant: Chiun Mai Communication Systems, Inc., New Taipei (TW)

(72) Inventors: HOW-WEN CHIEN, New Taipei (TW); SUNG-CHIEH CHANG, New Taipei (TW)

(21) Appl. No.: 15/716,440

(22) Filed: Sep. 26, 2017

(30) Foreign Application Priority Data
Sep. 27, 2016 (CN) 201610853456.1

(51) Int. Cl. G06F 3/041; G06K 9/00

(52) U.S. Cl. CPC G06F 3/0414; G06F 2203/04104; G06K 9/00067; G06K 9/00013

(57) ABSTRACT

An electronic device includes a touch screen, a touch sensor, and a processor. The touch sensor detects an operation feature inputted by the user when the touch screen is in a locked state. The processor receives the operation feature of the user detected by the touch sensor and determines whether the processor stores an operation feature matching the operation feature of the user. When the processor stores an operation feature matching the operation feature of the user, the processor controls the touch screen to switch from the locked state to an unlocked state and actuate an application program or a file corresponding to the operation feature stored in the processor. When the processor does not store an operation feature matching the operation feature of the user, the processor controls the touch screen to keep in the locked state.

### CROSS-REFERENCE TO RELATED APPLICATIONS

This application claims priority to Chinese Patent Application No. 201610853456.1 filed on Sep. 27, 2016, the contents of which are incorporated by reference herein.

### FIELD

The subject matter herein generally relates to an electronic device and a method for controlling the electronic device.

### BACKGROUND

Nowadays, many consumer electronics products, for example, mobile phones or tablet personal computers (PCs) have a touch screen. People can watch video, pictures, browse web pages, play games, and choose and manipulate objects on the touch screen. However, an application of the electronic device can only be actuated after the mobile terminal is unlocked and the function icon of the application on the touch screen is correspondingly clicked or doubled-clicked. When the electronic device includes a plurality of applications, the application icons are also increased. Then, a traditional way for finding and clicking the icon to load the application will cause a cumbersome operation, reduce a user's experience, and thus is inconvenient.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout several views.

FIG. 1 is a block diagram of an electronic device according to an exemplary embodiment of the present disclosure.

FIG. 2 is a block diagram of a processor of the electronic device of FIG. 1.

FIG. 3 is a flowchart of a method for controlling an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

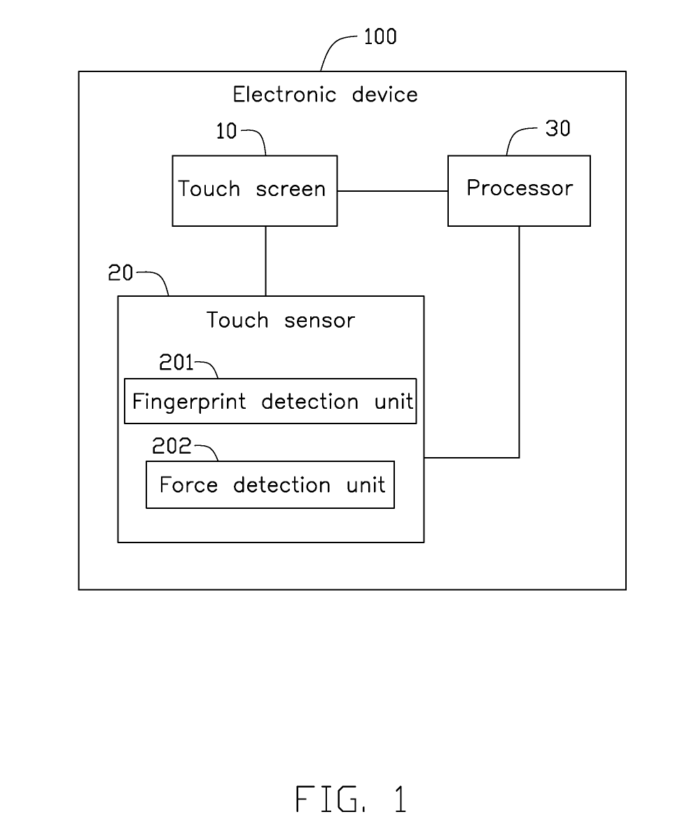

FIG. 1 illustrates an electronic device 100 according to an exemplary embodiment. The electronic device 100 includes a touch screen 10, a touch sensor 20, and a processor 30. The touch screen 10 receives operation features inputted by a user, for example, fingerprint features and pressing forces. The touch sensor 20 detects the operation features inputted by the user when the touch screen 10 is in a locked state. The processor 30 controls the touch screen 10 to switch from the locked state to an unlocked state based on the operation features detected by the touch sensor 20. The processor 30 further actuates an application program or a file corresponding to the operational feature. In this exemplary embodiment, the electronic device 100 may be an intelligent terminal, such as a mobile phone, a tablet computer, a smart watch, or the like.

In this exemplary embodiment, the touch sensor 20 includes a fingerprint detection unit 201 and a force detection unit 202. The fingerprint detection unit 201 and the force detection unit 202 are both electrically connected to the processor 30. The fingerprint detection unit 201 detects a fingerprint feature of a user on the touch screen 10, for example, a fingerprint feature of a finger or a plurality of fingers simultaneously pressed on the touch screen 10. The fingerprint detection unit 201 further sends the detected fingerprint feature to the processor 30. The force detection unit 202 detects a pressing force of each finger of the user when one finger or a plurality of fingers of the user press on the touch screen 10. The force detection unit 202 further sends the detected pressing force to the processor 30.

In this exemplary embodiment, each operation feature of the user detected by the touch sensor 20 is a combination of at least one fingerprint feature and at least one pressing force of at least one finger. The following Table 1 illustrates an exemplary example of six operation features inputted by the user. For example, as illustrated in Table 1, the operation feature 1 represents that the right forefinger of the user presses the touch screen 10 with a first force. The operation feature 2 represents that the right thumb of the user presses the touch screen 10 with the first force. The operation feature 3 represents that the right thumb of the user presses the touch screen 10 with a second force. The operation feature 4 represents that the two forefingers of the user both press the touch screen 10 with the first force. The operation feature 5 represents that the right forefinger of the user presses the touch screen 10 with the first force, the right middle finger of the user presses the touch screen 10 with the first force, and the right ring finger of the user presses the touch screen 10 with the second force. The operation feature 6 represents that the left forefinger of the user presses the touch screen 10 with the first force, the left middle finger of the user presses the touch screen 10 with the second force, the right forefinger of the user presses the touch screen 10 with a third force, and the right middle finger of the user pressing the touch screen 10 with a fourth force.

TABLE 1

| No | Operation Features Inputted By The User |
|---|---|
| 1 | The right forefinger pressing with a first force |
| 2 | The right thumb pressing with the first force |
| 3 | The right thumb pressing with a second force |
| 4 | The two forefingers both pressing with the first force |
| 5 | The right forefinger pressing with the first force, |
| | The right middle finger pressing with the first force, and |
| | The right ring finger pressing with the second force |
| 6 | The left forefinger pressing with the first force, |
| | The left middle finger pressing with the second force, |
| | The right forefinger pressing with a third force, and |
| | The right middle finger pressing with a fourth force |
| . . . | . . . |

In other exemplary embodiments, the operation features inputted by the user are not limited to those listed in Table 1. Each operation feature may be a combination of at least one finger and the pressing force of each finger.

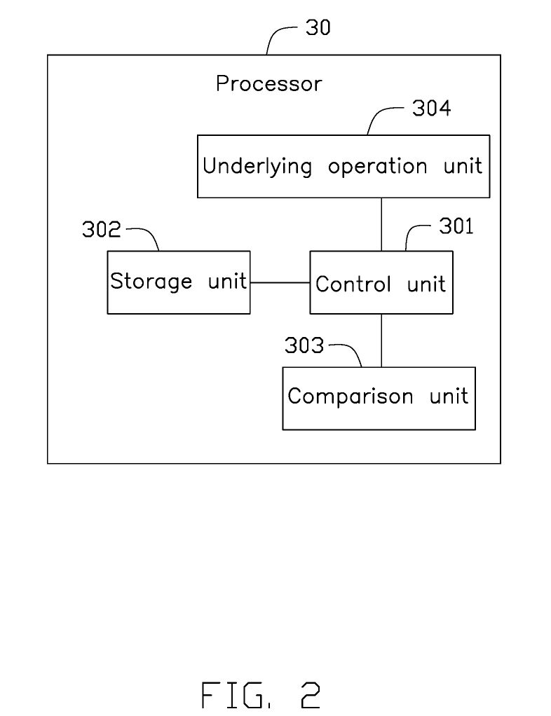

As illustrated in FIG. 2, the processor 30 includes a control unit 301, a storage unit 302, a comparison unit 303, and an underlying operation unit 304. The storage unit 302, the comparison unit 303, and the underlying operation unit 304 are all electrically connected to the control unit 301.

The storage unit 302 predefines and stores the operation features of the user. In this exemplary embodiment, each operation feature of the user defined by the storage unit 302 is also a combination of at least one fingerprint feature and at least one pressing force of at least one finger.

The following Table 2 illustrates the operation features predefined and stored by the storage unit 302. For example, as illustrated in Table 2, the storage unit 302 defines a combination of a fingerprint feature of the right forefinger and a predetermined first force as an operation feature, for example, an operation feature 1. The storage unit 302 defines a combination of a fingerprint feature of the right thumb and a predetermined first force as an operation feature, for example, the operation feature 2. The storage unit 302 defines a combination of a fingerprint feature of the right thumb and a predetermined second force as an operation feature, for example, the operation feature 3. The storage unit 302 defines a combination of a fingerprint feature of the right thumb and a predetermined first force, a fingerprint feature of the left thumb and a predetermined first force as an operation feature, for example, the operation feature 4. The storage unit 302 defines a combination of a fingerprint feature of the right forefinger and a predetermined first force, a fingerprint feature of the right middle finger and the predetermined first force, a fingerprint feature of the right ring finger and a predetermined second force as an operation feature, for example, the operation feature 5. The storage unit 302 defines a combination of a fingerprint feature of the left forefinger and a predetermined first force, a fingerprint feature of the left middle finger and the predetermined second force, a fingerprint feature of the right forefinger and a predetermined third force, a fingerprint feature of the right middle finger and a predetermined fourth force as an operation feature, for example, the operation feature 6.

TABLE 2

| | | Application |
|---|---|---|
| No | Predefined Operation Features | Programs Or Files |
| 1 | A fingerprint feature of the right forefinger and | A first application |
| | a predetermined first force | program |
| 2 | A fingerprint feature of the right thumb and a | A first file |
| | predetermined first force | |
| 3 | A fingerprint feature of the right thumb and a | A second |
| | predetermined second force | application program |
| 4 | A fingerprint feature of the left forefinger and a | A third application |
| | predetermined first force; | program |
| | A fingerprint feature of the right forefinger and | |
| | a predetermined first force | |
| 5 | A fingerprint feature of the right forefinger and | A second file |
| | a predetermined first force; | |
| | A fingerprint feature of the right middle finger | |
| | and a predetermined first force; | |
| | A fingerprint feature of the right ring finger and | |
| | a predetermined second force | |
| 6 | A fingerprint feature of the left forefinger and a | A third file |
| | predetermined first force; | |
| | A fingerprint feature of the left middle finger | |
| | and a predetermined second force; | |
| | A fingerprint feature of the right forefinger and | |
| | a predetermined third force; | |
| | A fingerprint feature of the right middle finger | |
| | and a predetermined fourth force | |
| . . . | . . . | . . . |

As illustrated in Table 2, the storage unit 302 also predefines and stores a corresponding relationship between the operation features of the user and the application programs and/or files. For example, the operation feature 1 can be predefined to correspond to the first application program, the operation feature 2 can be predefined to correspond to the first file, the operation feature 3 can be predefined to correspond to the second application program, the operation feature 4 can be predefined to correspond to the third application program, the operation feature 5 can be predefined to correspond to the second file, and the operation feature 6 can be predefined to correspond to the third file.

In other exemplary embodiments, the operation features stored in the storage unit 302 are not limited to those listed in Table 2. Each operation feature may be a combination of at least one fingerprint feature and at least one pressing force of at least one finger. The relationship stored in the storage unit 302 is also not limited to Table 2, and each operation feature can correspond to a different application program or file.

The comparison unit 303 compares the operation feature of the user transmitted by the touch sensor 20 with the operation features pre-stored in the storage unit 302, and determines whether or not the storage unit 302 stores an operation feature matching the operation feature of the user transmitted by the touch sensor 20. In the course of the comparison, when the operation feature inputted by the user includes a plurality of fingers, the plurality of fingers of the operation feature must simultaneously press the touch screen 10. For example, when the operation feature 4 is inputted, the two forefingers of the user must simultaneously press the touch screen 10. For example, when the operation feature 6 is inputted, the two forefingers and two middle fingers of the user must simultaneously press the touch screen 10.

The comparison unit 303 may compare the operation feature inputted by the user with the operation features stored in the storage unit 302 one by one. In the course of the comparison of the operation feature inputted by the user with one pre-stored operation feature in the storage unit 302, it is necessary to ensure that the fingerprint feature of each finger of the user pressing on the touch screen 10 matches the fingerprint feature of the same finger of the one pre-stored operation feature and it is also necessary to ensure that the pressing force of each finger of the user pressing on the touch screen 10 is the same as the pressing force of the same finger of the one pre-stored operation feature so as to determine that the operation feature inputted by the user matches the one pre-stored operation feature stored in the storage unit 302.

For example, when the comparison unit 302 compares the operation feature of the user from the touch sensor 20 and the pre-stored operation feature 6 of the storage unit 302, only when the touch screen 10 is pressed by four fingers of the user, the four fingers are respectively the left forefinger, the left middle finger, the right forefinger, and the right middle finger, and the pressing forces of the four fingers of the user are respectively the first force, the second force, the third force, and the fourth force, the comparison unit 302 can determine the operation feature inputted by the user is matching the operation feature 6 pre-stored in the storage unit 302.

When the finger pressed on the touch screen 10 is different from the finger of the operation feature pre-stored in the storage unit 302, or a pressing force of any finger is different from the pressing force of the same finger of the operation feature pre-stored in the storage unit 302, the comparison unit 302 determines the operation feature inputted by the user is not matching the operation feature pre-stored in the storage unit 302.

When the operation feature inputted by the user is not matching each of the operation features pre-stored in the storage unit 302, the comparison unit 303 determines that the storage unit 302 does not store any operation feature which can matching the operation feature inputted by the user.

In this exemplary embodiment, when the comparison unit 303 compares the operation feature of the user with one operation feature pre-stored in the storage unit 302, the same pressing force means the pressing force outputted by a finger of the user equals the predetermined pressing force of the same finger of the operation feature pre-stored in the storage unit 302, or a difference between the pressing force outputted by a finger of the user and the predetermined pressing force of the same finger of the operation feature pre-stored in the storage unit 302 is less than a predetermined value. For example, when the pressing force outputted by a finger of the user equals the predetermined first force of the same finger of the operation feature pre-stored in the storage unit 302, or a difference between the pressing force outputted by a finger of the user and the predetermined first force of the same finger of the operation feature pre-stored in the storage unit 302 is less than the predetermined value, the pressing force outputted by the user is considered to be the same as the predetermined first force.

When the comparison unit 303 determines that the storage unit 302 stores an operation feature matching the operation feature of the user transmitted by the touch sensor 20, the control unit 301 controls the touch screen 10 to switch to an unlocked state from a locked state, and controls the underlying operation unit 304 to actuate an application program or a file corresponding to the operation feature.

For example, as illustrated in Table 1 and Table 2, when the touch screen 10 is in the locked state, the right forefinger of the user is pressed on the touch screen 10 with a first force. The fingerprint detection unit 201 detects the fingerprint feature of the finger and the force detection unit 202 detects the pressing force, that is, the operation feature of the user. The touch sensor 30 further sends the operation feature of the user to the comparison unit 303. The comparison unit 303 compares the operation feature of the user, that is, a combination of the fingerprint feature of the right forefinger and a pressing force of the right forefinger, with pre-stored operation features, so as to determine whether the storage unit 302 stores an operation feature matching the operation feature of the user.

When the comparison unit 303 determines that storage unit 302 stores an operation feature matching the detected operation feature of the user, for example, the fingerprint feature of the right forefinger is matching the fingerprint feature of the right forefinger of the predefined operation feature 1, the first force outputted by the user equals the predetermined first force or a difference between the first force and the predetermined first force is less than a predetermined value, the control unit 301 controls the touch screen 10 to the unlocked state, and controls the underlying operation unit 304 to actuate an application program or a file corresponding to the operation feature 1, for example, the first application program.

When the comparison unit 303 determines that the storage unit 302 does not store any operation feature matching the detected operation feature of the user, the control unit 301 controls the touch screen 10 to keep in the locked state. For example, when only the right forefinger is pressed on the touch screen 10, and a difference between the pressing force of the user and the predetermined first force is larger than the predetermined value, since the storage unit 302 does not store an operation feature matching the detected operation feature, the control unit 301 controls the touch screen 10 to keep in the locked state.

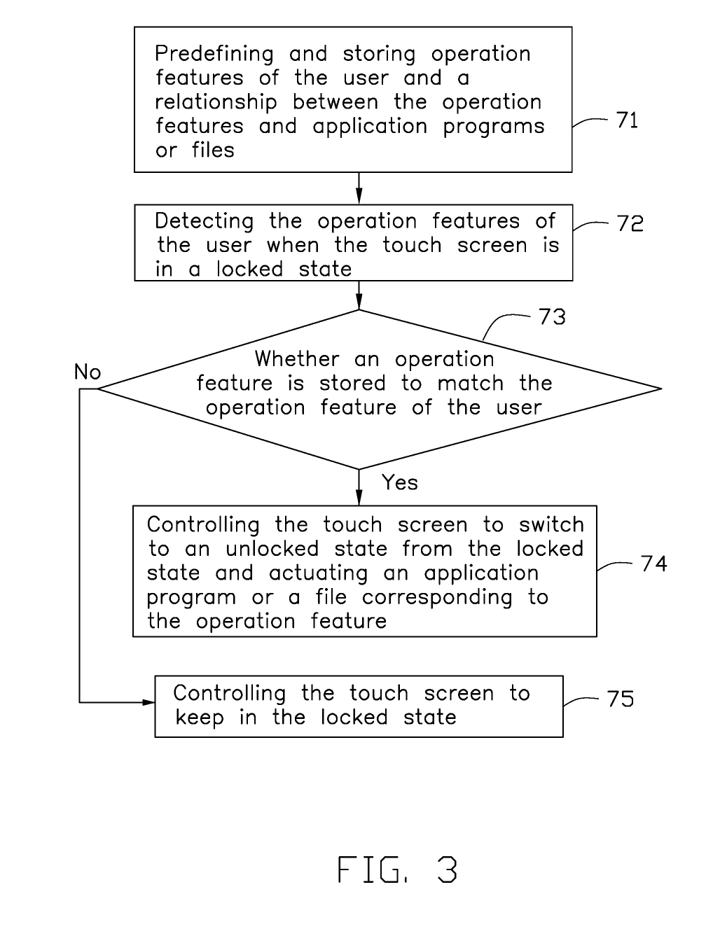

FIG. 3 illustrates a flowchart of a method for controlling an electronic device. The method is provided by way of example, as there are a variety of ways to carry out the method. Each block shown in FIG. 3 represents one or more processes, methods, or subroutines which are carried out in the example method. Furthermore, the order of blocks is illustrative only and additional blocks can be added or fewer blocks may be utilized without departing from the scope of this disclosure.

At block 71, predefining and storing the operation features of the user and a relationship between the operation features and the application programs or files. For example, the operation features shown in Table 2 and the relationship between the operation features and the application programs or files.

At block 72, when the touch screen 10 is in the locked state, the touch sensor 20 detects the operation features of the user and sends the detected operation features of the user to the comparison unit 303.

In this exemplary embodiment, the fingerprint detection unit 201 detects a fingerprint feature of a user on the touch screen 10, for example, a fingerprint feature of a finger or a plurality of fingers simultaneously presses on the touch screen 10. The fingerprint detection unit 201 further sends the detected fingerprint feature to the comparison unit 303. The force detection unit 202 detects a pressing force of each finger of the user when one finger or a plurality of fingers of the user presses on the touch screen 10. The force detection unit 202 further sends the detected pressing force to the comparison unit 303.

At block 73, the comparison unit 303 determines whether the storage unit 302 stores an operation feature matching the operation feature of the user transmitted by the touch sensor 20. When the comparison unit 303 determines that the storage unit 302 stores an operation feature matching the operation feature of the user transmitted by the touch sensor 20, block 74 is performed. When the comparison unit 303 determines that the storage unit 302 does not store an operation feature matching the operation feature of the user transmitted by the touch sensor 20, block 75 is performed.

At block 74, when the storage unit 302 stores an operation feature matching the operation feature of the user transmitted by the touch sensor 20, the control unit 301 controls the touch screen 10 to switch to an unlocked state from the locked state, and controls the underlying operation unit 304 to actuate an application program or a file corresponding to the operation feature stored in the storage unit 302.

At block 75, when the storage unit 302 does not store an operation feature matching the operation feature of the user transmitted by the touch sensor 20, the control unit 301 controls the touch screen 10 to keep in the locked state.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An electronic device, comprising:
a touch screen;
a touch sensor, the touch sensor detecting an operation feature inputted by the user when the touch screen is in a locked state; and
a processor, the processor receiving the operation feature of the user detected by the touch sensor and determining whether the processor stores an operation feature matching the operation feature of the user;
wherein when the processor stores an operation feature matching the operation feature of the user, the processor controls the touch screen to switch from the locked state to an unlocked state and actuate an application program or a file corresponding to the operation feature stored in the processor; and
wherein when the processor does not store an operation feature matching the operation feature of the user, the processor controls the touch screen to keep in the locked state.

2. The electronic device of claim 1, wherein the touch sensor comprises a fingerprint detection unit and a force detection unit, the fingerprint detection unit detects a fingerprint feature of the user on the touch screen and sends the detected fingerprint feature to the processor; wherein the force detection unit detects a pressing force of each finger of the user when one finger or a plurality of fingers of the user press on the touch screen and sends the detected pressing force to the processor.

3. The electronic device of claim 1, wherein the processor comprises a storage unit, the storage unit predefines and stores operation features of the user and a relationship between the predefined operation features and application programs and/or files.

4. The electronic device of claim 1, wherein each operation feature is a combination of at least one fingerprint feature and at least one pressing force of at least one finger.

5. The electronic device of claim 4, wherein when a fingerprint feature of each finger of the user pressing the touch screen matches a fingerprint feature of the same finger of an operation feature pre-stored in the processor, and a pressing force of each finger of the user pressing the touch screen is the same as a pressing force of the same finger of the operation feature pre-stored in the processor, the processor determines that the processor stores an operation feature matching the operation feature inputted by the user.

6. The electronic device of claim 5, wherein the pressing force of a finger of the user pressing the touch screen is the same as the pressing force of the same finger of the operation feature pre-stored in the processor means that the pressing force of the finger of the user equals the pressing force of the same finger of the operation feature pre-stored in the processor.

7. The electronic device of claim 4, wherein the pressing force of a finger of the finger pressing the touch screen is the same as the pressing force of the same finger of the operation feature pre-stored in the processor means that a difference between the pressing force of the finger of the user and the pressing force of the same finger of the operation feature pre-stored in the processor is less than a predetermined value.

8. A method for controlling an electronic device, the electronic device comprising a touch screen and a storage unit; the method comprising:
(a) predefining and storing operation features of a user and a relationship between the operation features and application programs and/or files in the storage unit;
(b) detecting the operation feature of the user when the touch screen is in a locked state;
(c) receiving the operation feature of the user and determining whether the storage unit stores an operation feature matching the operation feature of the user;
(d) controlling the touch screen to switch to an unlocked state from the locked state, and actuating an application program or a file corresponding to the operation feature when the storage unit stores an operation feature matching the operation feature of the user; and
(e) controlling the touch screen to keep in the locked state when the storage unit does not store an operation feature matching the operation feature of the user.

9. The method of claim 8, wherein each operation feature of the user is a combination of at least one fingerprint feature and at least one pressing force of at least one finger.

10. The method of claim 8, wherein when a fingerprint feature of each finger of the user pressing the touch screen matches a fingerprint feature of the same finger of an operation feature pre-stored in the storage unit, and a pressing force of each finger of the user pressing the touch screen is the same as a pressing force of the same finger of the operation feature pre-stored in the storage unit , the processor determines that the storage unit stores an operation feature matching the operation feature inputted by the user.

11. The method of claim 10, wherein the pressing force of a finger of the user pressing the touch screen is the same as the pressing force of the same finger of the operation feature pre-stored in the processor means that the pressing force of the finger of the user equals the pressing force of the same finger of the operation feature pre-stored in the processor.

12. The method of claim 10, wherein the pressing force of a finger of the finger pressing the touch screen is the same as the pressing force of the same finger of the operation feature pre-stored in the processor means that a difference between the pressing force of the finger of the user and the pressing force of the same finger of the operation feature pre-stored in the processor is less than a predetermined value.
